(19) United States
(12) Patent Application Publication
(10) Pub. No.: US 2011/0310433 A1
(43) Pub. Date: Dec. 22, 2011

(54) PRINT DATA DELIVERY DEVICE, IMAGE FORMING APPARATUS AND IMAGE FORMING SYSTEM

(75) Inventor: Takahiro Hagiwara, Chiba-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/160,754

(22) Filed: Jun. 15, 2011

Related U.S. Application Data
(60) Provisional application No. 61/355,840, filed on Jun. 17, 2010.

(51) Int. Cl. G06K 15/00

(52) U.S. Cl. 358/1.15

(57) ABSTRACT

A print data delivery device includes: a print data receiving unit which receives print data which is transmitted from a client terminal; a transmission source information acquisition unit which acquires transmission source identification information corresponding to a transmission source for the print data which is received by the print data receiving unit; a delivery destination determination unit which determines as a print data delivery destination at least one image forming apparatus which is associated in advance with the transmission source identification information; and a print data delivery unit which delivers the print data received by the print data receiving unit toward the at least one image forming apparatus which is determined by the delivery destination determination unit.

### CROSS-REFERENCE TO RELATED APPLICATION

This application is based upon and claims the benefit of priority from U.S. provisional application 61/355,840, filed on Jun. 17, 2010; the entire contents all of which are incorporated herein by reference.

### FIELD

Embodiments described herein relate generally to a print data delivery technique for delivering print data which is transmitted from a client terminal to a plurality of image forming apparatuses.

### BACKGROUND

In the related art, printing management systems are known in which print jobs as print data are registered in a print server from a network terminal, and a print job which is registered in the print server is selected through an operation panel of an image forming apparatus and is downloaded from print server to perform printing.

In such a printing management system, since the printing is started after selection of the print job through the operation panel of the image forming apparatus, the total time including a time for downloading the print data to the image forming apparatus from the print server, a raster image process time for rasterizing the print data, a printing time for printing a raster image on a sheet, and the like becomes a printing waiting time.

Accordingly, there is known a technique to shorten the printing waiting time by a method in which the print data is previously downloaded to the image forming apparatus and is subjected to a raster image process to print the raster image on a sheet at the time when there is a printing request of a user.

However, when the related technique is used in circumstances where the number of users is large and a plurality of image forming apparatuses are thus used, the print data is sent to the plurality of image forming apparatuses from the print server, and thus network traffic due to a transmission of large amounts of print data increases and an unnecessary raster image process, which is performed in the image forming apparatus, but has no relationship with an actual printing, increases, whereby there is concern that the printing waiting time increases.

### DESCRIPTION OF THE DRAWINGS

FIG. 1 is a diagram showing the schematic configuration of an image forming system according to this embodiment.

FIG. 2 is a functional block diagram of the image forming system.

FIG. 3 is a diagram for explaining a delivery of print data in the image forming system.

FIG. 4 is a diagram showing the configuration of a print data delivery device 1 in detail.

FIG. 5 is a diagram showing a data set of a statistical information database which is used in order to predict an image forming apparatus 2 to be used in printing.

FIG. 6 is a diagram showing a data set of a statistical information database which is used in order to predict the image forming apparatus 2 to be used in the printing.

FIG. 7 is a diagram showing a data set of a statistical information database which is used in order to predict the image forming apparatus 2 to be used in the printing.

FIG. 8 is a diagram showing a data set of a statistical information database which is used in order to predict the image forming apparatus 2 to be used in the printing.

FIG. 9 is a diagram showing a data set of a statistical information database which is used in order to predict the image forming apparatus 2 to be used in the printing.

FIG. 10 is a diagram showing a data set of a statistical information database which is used in order to predict the image forming apparatus 2 to be used in the printing.

FIG. 11 is a flowchart showing the flow of a process in the print data delivery device.

FIG. 12 is a flowchart showing the flow of a process in the print data delivery device.

FIG. 13 is a table showing a print job record.

FIG. 14 is a table showing a print data delivery and a print result record.

FIG. 15 is a table showing a print result exception record.

FIG. 16 is a table of a print result summary.

FIG. 17 is a table in which items are gathered for each of the image forming apparatuses to which print data is previously delivered and are ranked in descending order according to an evaluation value for previous delivery of print data.

FIG. 18 is a table showing exception process information.

FIG. 19 is a table showing job control instruction settings in an exception process.

FIG. 20 is a table for explaining another method of calculating an Evaluation Value for Previous Delivery of print data for previously delivering print data.

FIG. 21 is a table for explaining yet another method of calculating the Evaluation Value for Previous Delivery of print data for previously delivering print data.

FIG. 22 is a diagram for explaining the flow of control as a whole image forming system.

### DETAILED DESCRIPTION

In general, according to an embodiment, a print data delivery device has a print data receiving unit, a transmission source information acquisition unit, a delivery destination determination unit, and a print data delivery unit. The print data receiving unit receives print data which is transmitted from a client terminal. The transmission source information acquisition unit acquires transmission source identification information corresponding to a transmission source of the print data which is received by the print data receiving unit. The delivery destination determination unit determines as a print data delivery destination at least one image forming apparatus which is associated in advance with the transmission source identification information as an apparatus which is selected at a frequency which is equal to or more than a predetermined number of times within a predetermined period of time to be allowed to execute printing based on the print data by a user corresponding to the transmission source identification information which is acquired by the transmission source information acquisition unit. The print data delivery unit delivers the print data received by the print data receiving unit toward the at least one image forming apparatus which is determined by the delivery destination determination unit.

In addition, according to the embodiment, the image forming apparatus has a print data receiving unit, a command analysis unit, and a process start control unit. The print data receiving unit receives the print data which is delivered from the print data delivery device. The command analysis unit analyzes an execution control command which is added to the print data. The process start control unit controls an execution start timing of a predetermined process based on the print data which is received by the print data receiving unit on the basis of the execution control command which is analyzed by the command analysis unit.

In addition, according to the embodiment, an image forming system has a print data receiving unit, a transmission source information acquisition unit, a delivery destination determination unit, a print data delivery unit, a print data receiving unit, a command analysis unit, and a process start control unit.

Hereinafter, embodiments will be described with reference to the drawings.

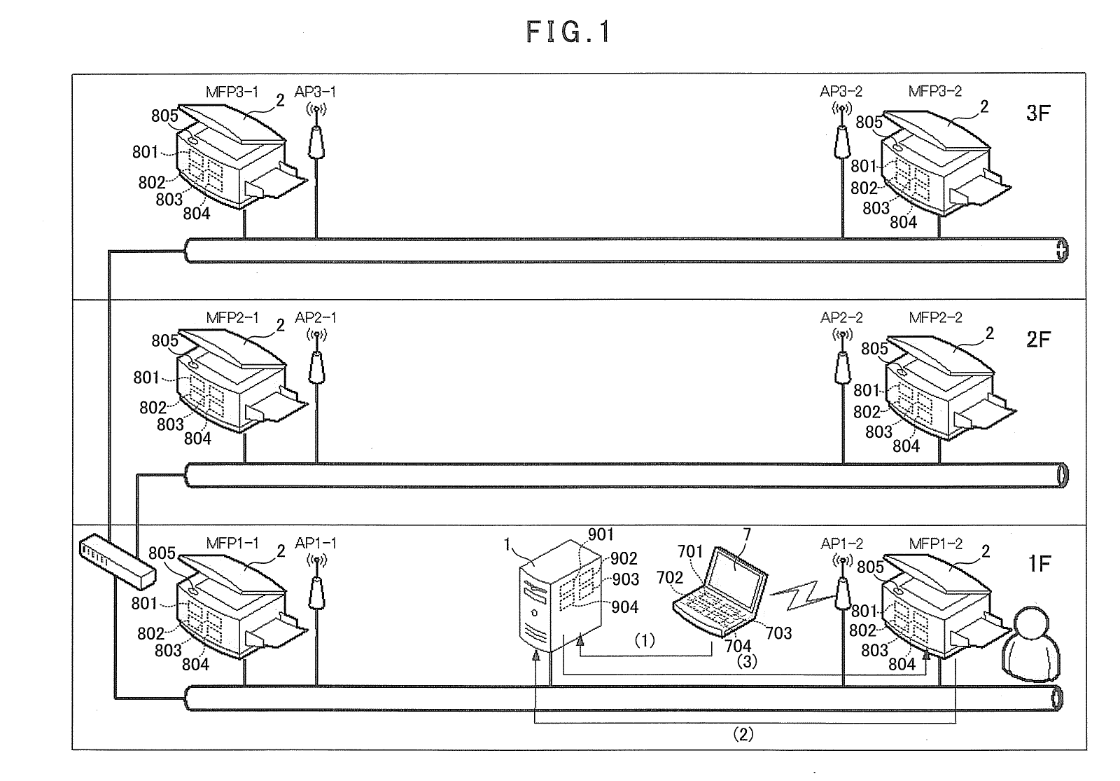

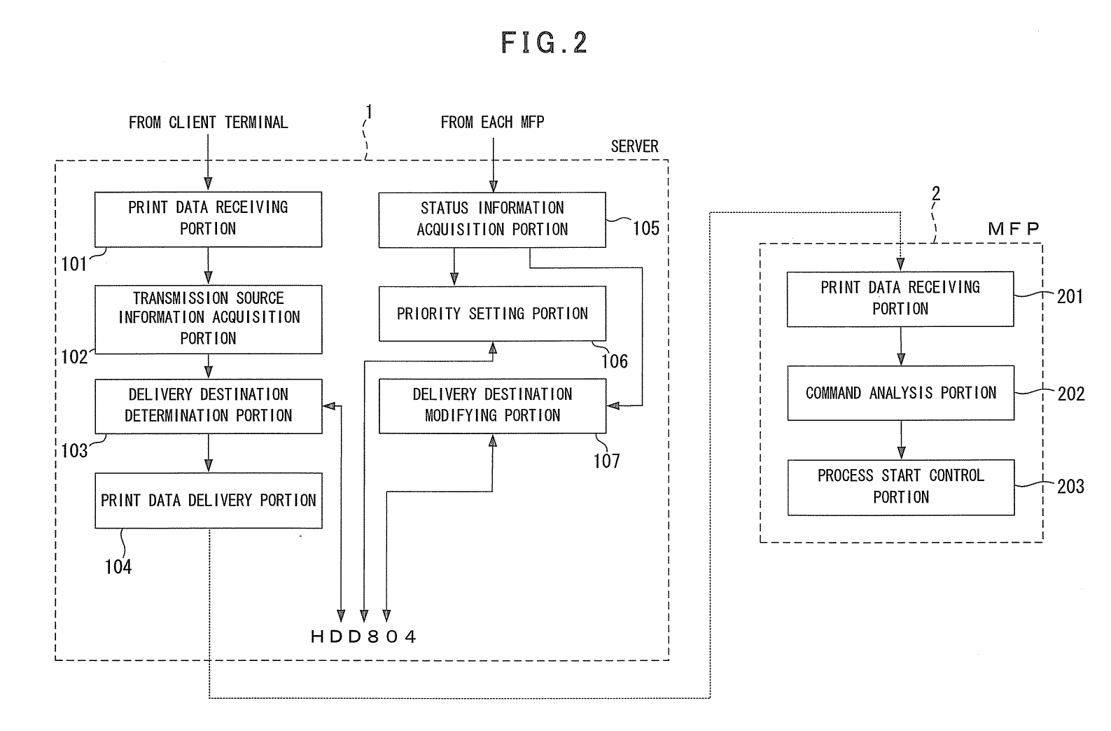

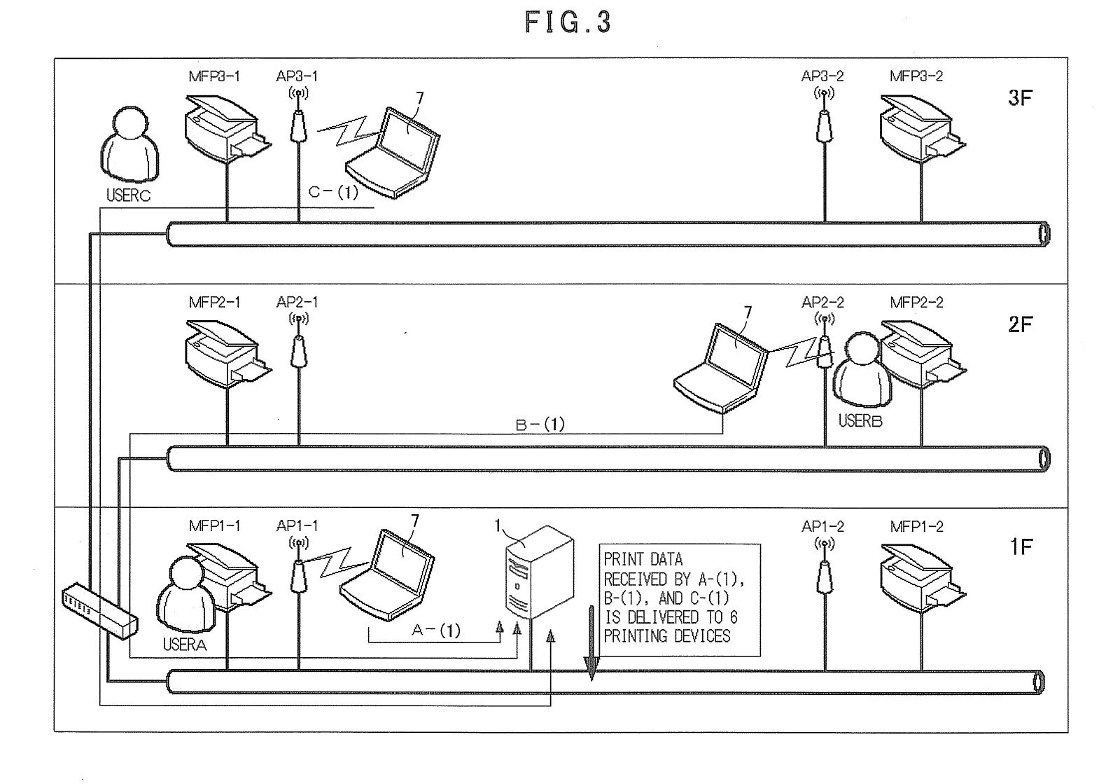

FIG. 1 is a diagram showing the schematic configuration of an image forming system according to this embodiment. FIG. 2 is a functional block diagram of the image forming system according to this embodiment. FIG. 3 is a diagram for explaining a delivery of print data in the image forming system according to this embodiment.

The image forming system according to this embodiment includes a print data delivery device 1 as a server and a plurality of image forming apparatuses 2 as client terminals.

The print data delivery device 1 and the plurality of image forming apparatuses 2 are connected so as to communicate with each other through an electric communication line (whether wired or wireless) such as a local area network (LAN).

The print data delivery device 1 functions as a server and includes a processor 901, an application specific integrated circuit (ASIC) 902, a memory 903, and a hard disk drive (HDD) 904. The processor 901 executes a program which is stored in the memory 903 or the HDD 904 and thus realizes various processes such as a determination process and a data transmission process in the print data delivery device 1. In addition, the ASIC 902 performs various processes with reference to various information stored in the memory 903 and the HDD 904.

Each of the plurality of image forming apparatuses 2 includes a processor 801, an ASIC 802, a memory 803, a HDD 804, and an operation input portion 805. The processor 801 executes a program which is stored in the memory 803 or the HDD 804 and thus realizes various processes such as data transmission and reception and a printing in the image forming apparatus 2. The ASIC 802 performs various processes with reference to various information stored in the memory 803 and the HDD 804. The operation input portion 805 can be constituted of, for example, a keyboard, a touch panel, a touchpad, a graphics tablet, a dedicated button or the like. In addition, it is also possible to realize functions of a display portion and the operation input portion by a so-called touch panel display.

A client terminal 7 is a PC which is used as a network terminal by a user and includes a processor 701, an ASIC 702, a memory 703, and a HDD 704. The processor 701 executes a program which is stored in the memory 703 or the HDD 704 and thus realizes various processes such as data transmission, print setting and printing instruction in the client terminal 7. In addition, the ASIC 702 performs various processes with reference to various information stored in the memory 703 and the HDD 704. The client terminal 7 communicates with the print data delivery device 1 via communication equipment such as access points AP1-1 to AP3-2 (see FIG. 1). A user transmits print data toward the print data delivery device 1 by using a print driver or the like installed in the client terminal 7.

First, the print data delivery device 1 will be described.

The print data delivery device 1 includes a print data receiving portion 101, a transmission source information acquisition portion 102, a delivery destination determination portion 103, a print data delivery portion 104, a status information acquisition portion 105, a priority setting portion 106, and a delivery destination modifying portion 107.

The print data receiving portion 101 receives print data (print job) which is transmitted from the client terminal (see FIG. 3).

The transmission source information acquisition portion 102 acquires transmission source identification information corresponding to a transmission source of the print data which is received by the print data receiving portion 101.

Specifically, examples of the transmission source identification information include:

(1) IP Address Version 4 of Client Terminal;

(2) IP Address Version 6 of Client Terminal;

(3) MAC Address of Client Terminal;

(4) Media Access Control (MAC) Address of Network Device for Connecting Client Terminal to Network; and

(5) User ID.

The delivery destination determination portion 103 determines as a print data delivery destination at least one image forming apparatus which is associated in advance with the transmission source identification information as an apparatus which is selected at a frequency which is equal to or more than a predetermined number of times within a predetermined period of time to be allowed to execute the printing based on the print data by a user corresponding to the transmission source identification information which is acquired by the transmission source information acquisition portion 102.

The print data delivery portion 104 delivers the print data which is received by the print data receiving portion 101 toward at least one image forming apparatus which is determined as a delivery destination candidate by the delivery destination determination portion 103 (See FIG. 3).

The status information acquisition portion 105 acquires execution status information showing the image forming apparatus which is actually selected by a user as an apparatus which is allowed to execute the printing based on the received print data among the plurality of image forming apparatuses to which the print data was delivered in association with the transmission source identification information corresponding to each print data.

When a certain image forming apparatus shown by the execution status information which is acquired by the status information acquisition portion 105 in association with arbitrary transmission source identification information is not associated with the transmission source identification information in advance, the delivery destination determination portion 103 can also add the certain image forming apparatus to the print data delivery destination for a predetermined period of time. Here, the example is shown in which the certain image forming apparatus is added to the print data delivery destination, but the exemplary embodiments described herein are not limited thereto. For example, a command may be transmitted together with the print data to instruct the certain image forming apparatus to rapidly execute a RIP process.

On the basis of the information which is acquired by the status information acquisition portion 105, the priority setting portion 106 sets a priority higher for an image forming apparatus which was selected at a high frequency in the past as an apparatus which is allowed to execute the printing based on the print data.

The print data delivery portion 104 preferentially delivers the print data to the image forming apparatus of which the priority set by the priority setting portion 106 is high.

The print data delivery portion 104 sets, in each print data to be delivered, an execution control command to preferentially start the execution of a predetermined process based on the delivered print data for an image forming apparatus of which the priority set by the priority setting portion 106 is high.

Here, examples of the predetermined process based on the print data include the raster image processing (RIP).

The delivery destination modifying portion 107 modifies at least one image forming apparatus as a delivery destination which is associated in advance with the transmission source identification information.

Next, the image forming apparatus 2 will be described.

The image forming apparatus 2 includes a print data receiving portion 201, a command analysis portion 202, and a process start control portion 203.

The print data receiving portion 201 receives print data which is delivered from the print data delivery device 1.

The command analysis portion 202 analyzes an execution control command which is added to the print data.

The process start control portion 203 controls an execution start timing of a predetermined process based on the print data which is received by the print data receiving portion on the basis of the execution control command which is analyzed by the command analysis portion 202.

Needless to say, in the image forming system according to this embodiment, the processors 701, 801 and 901 can be realized by a central processing unit (CPU) or a micro processing unit (MPU) which can execute the same computation. In the same manner, the HDDs 804 and 204 can be replaced with a storage device such as a flash memory.

The memories 703, 803, and 903 can be constituted of, for example, a random access memory (RAM), a read only memory (ROM), a dynamic random access memory (DRAM), a static random access memory (SRAM), a video RAM (VRAM), a flash memory or the like, and serve as a unit for storing the various information and programs which are used in the image forming system.

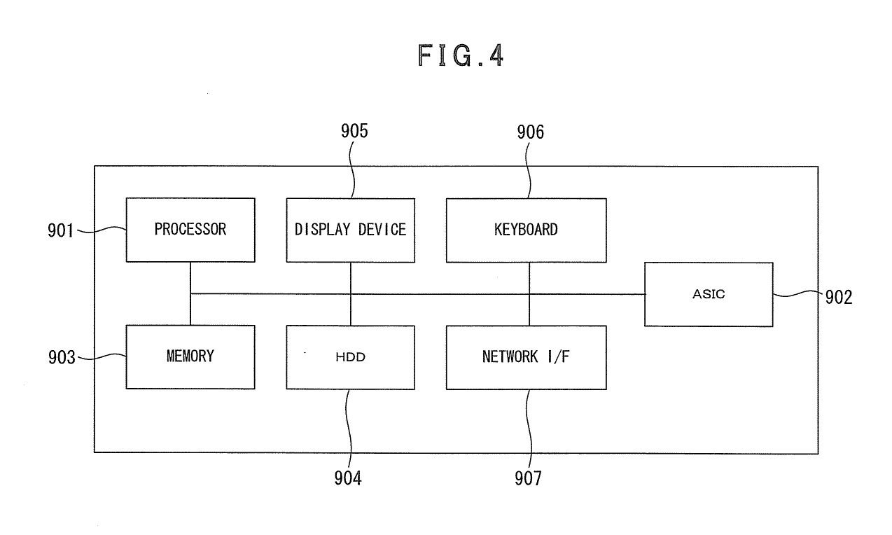

FIG. 4 is a diagram showing the configuration of the print data delivery device 1 in detail.

The processor 901 executes a control program of the print data delivery device 1.

The memory 903 holds the control program of the print data delivery device 1, which is read out from the HDD 904, so as to be used by the processor 901, or is used as a work area necessary for execution.

The HDD 904 stores the control program of the print data delivery device 1 or stores data of a statistical information database to be described later.

A keyboard 906 and a display device 905 are interfaces for performing the setting operation and the operation input by a user in the print data delivery device 1.

A network I/F 907 is an interface for transmitting and receiving print data to and from each image forming apparatus 2 connected to the LAN or transmitting and receiving a control command and the like to perform the control of the image forming apparatuses 2 and the like.

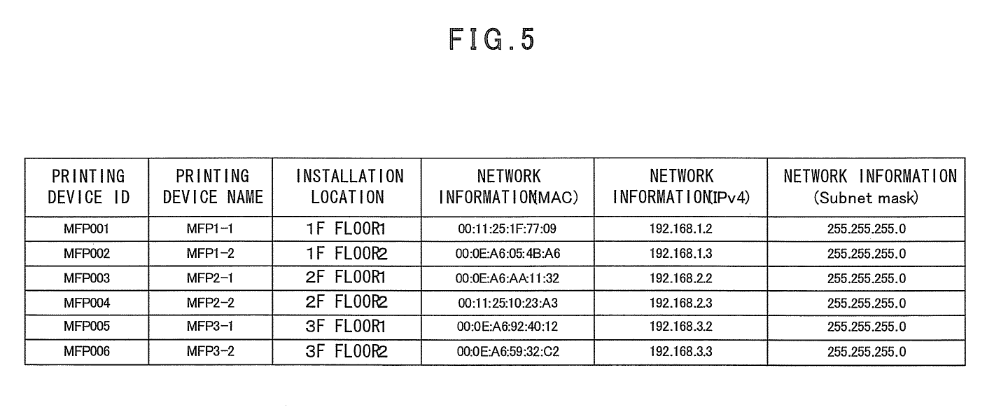

FIGS. 5 to 10 are diagrams showing a data set of the statistical information database which is used by the print data delivery device 1 in order to predict the image forming apparatus 2 to be used in the printing by a user.

FIG. 5 shows image forming apparatus registration information in which network information and installation locations of the image forming apparatuses which are managed by the print data delivery device 1 are registered.

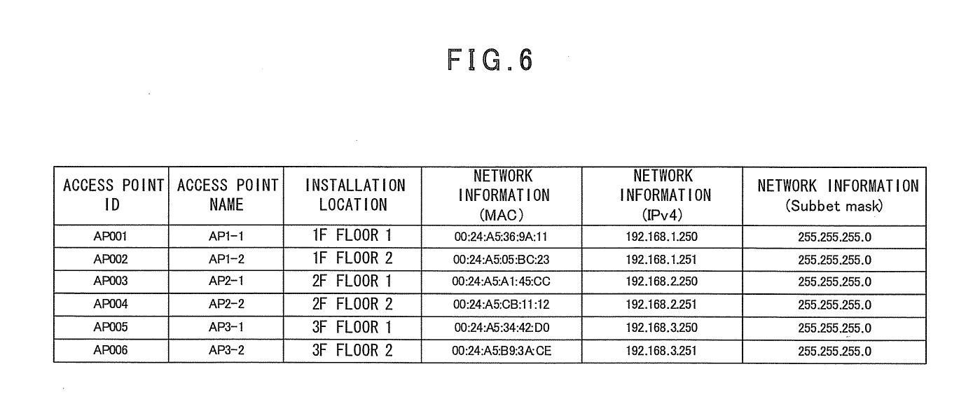

FIG. 6 shows access point registration information in which network information and installation locations of the access points which are used when the client terminals are connected by a wireless LAN are registered.

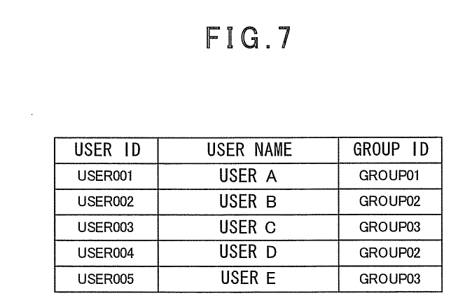

FIG. 7 shows user registration information in which user names and groups to which users are assigned are registered.

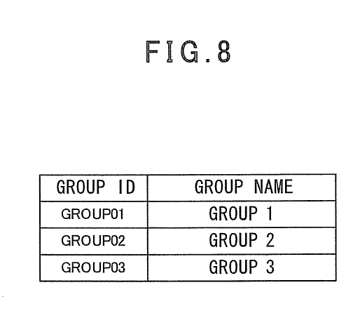

FIG. 8 shows group registration information in which names of the groups to which users are assigned are registered.

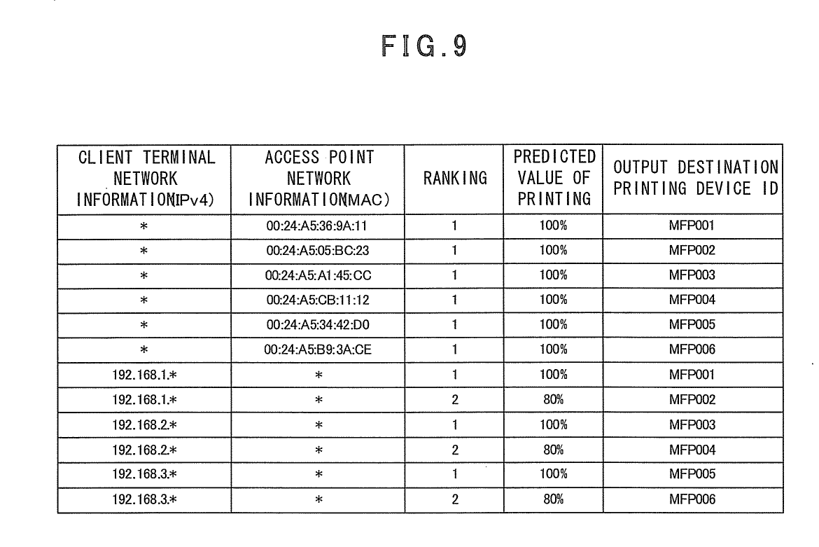

FIG. 9 shows print data delivery destination ranking information which is used for the print data delivery device 1 to determine an image forming apparatus to which the print data is to be delivered in advance on the basis of the network information which is sent from the client terminal, and this is set by a manager from the network information and the positional relationship between the image forming apparatuses. The IP addresses described in the table are written in the version 4, but the version 6, which is a new standard, also may be added.

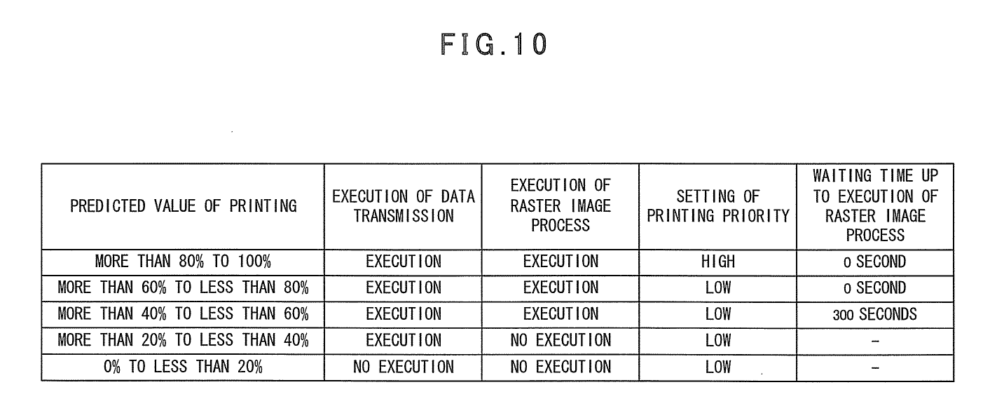

FIG. 10 shows setting information for controlling how the printing is executed in the image forming apparatus, and this is added to the print data which is sent in advance to the image forming apparatus by the print data delivery device 1 to control the execution timing, the priority and the like of the printing of the image forming apparatus.

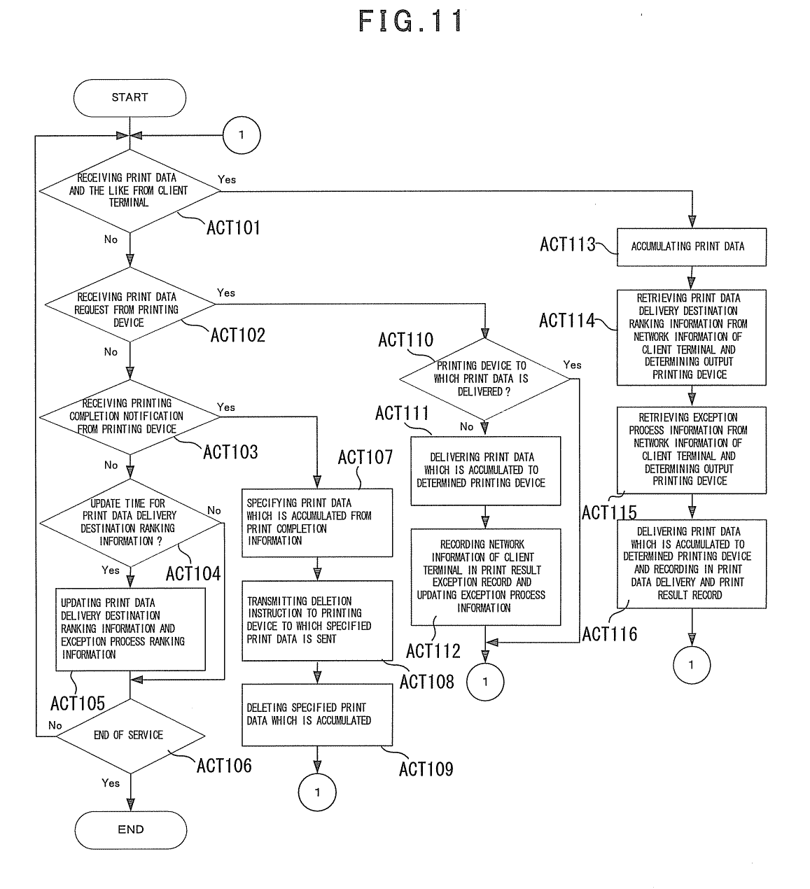

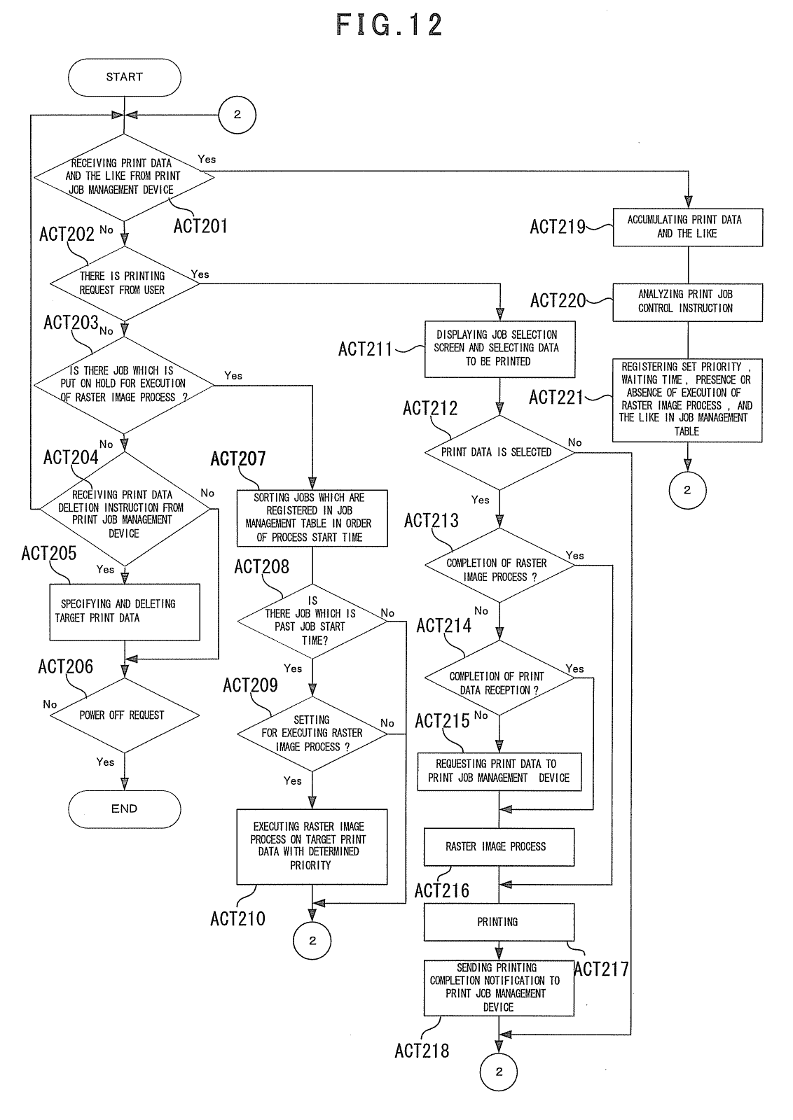

FIGS. 11 and 12 are flowcharts showing the flow of a process in the print data delivery device 1.

First, the flow of the control for shortening a user's printing waiting time will be described using the flowchart of FIG. 11.

In this embodiment, the control program of the print data delivery device 1 is stored in the HDD 904, and if necessary, the control program is read out and executed by the processor 901 to realize the following process.

When the program is run by the print data delivery device 1 and the service is started, monitoring of the “network information (IP address, MAC address and the like)” and the “print data” which are sent from the client terminal 7 and “print data request notification” which is sent from the image forming apparatus (ACT 110 to ACT 112) and monitoring of “printing completion notification” (ACT 107 to ACT 109) are repeated on a regular basis until there is a service stop request (ACT 101 to ACT 103, ACT 106).

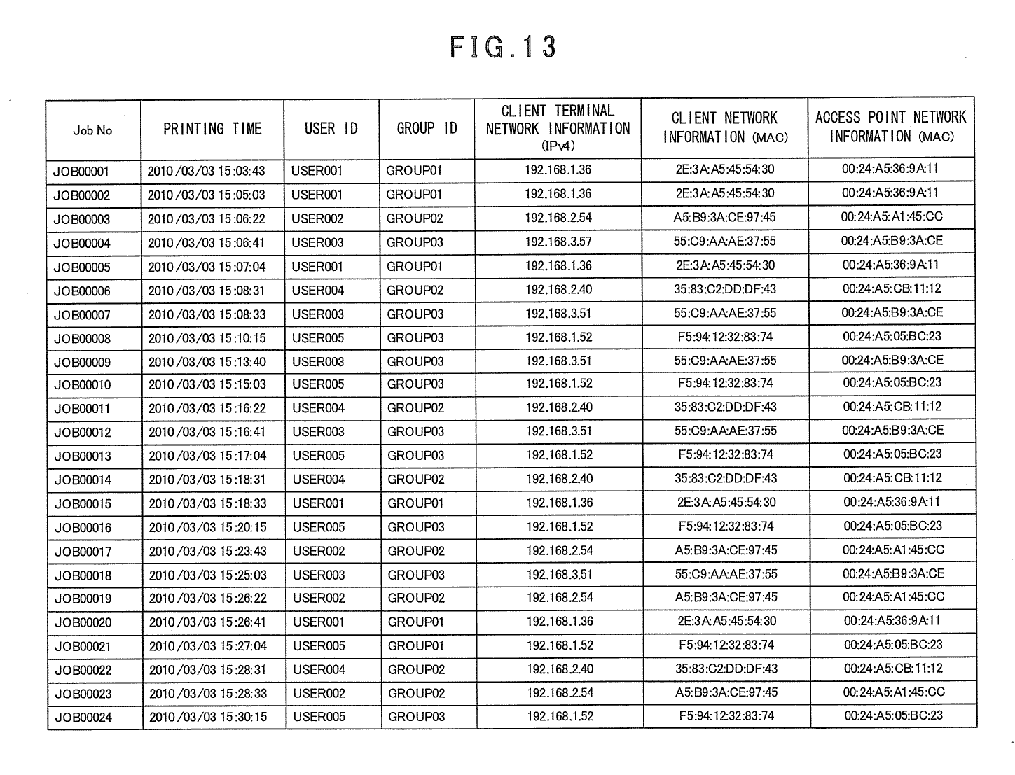

When detecting that the print data is sent from the client terminal (ACT 101, YES), the processor 901 receives the sent print data, temporarily accumulates the print data in an auxiliary storage device such as the HDD 904 (ACT 113), and records the print data as print job information on the HDD 904 as shown in FIG. 13.

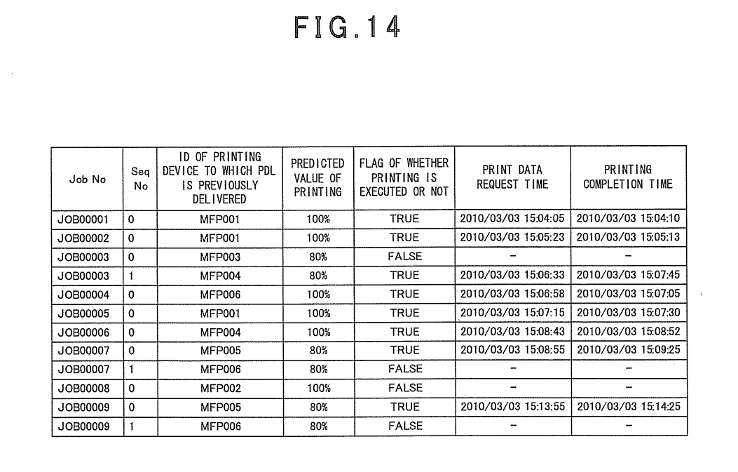

In addition, the processor 901 retrieves the print data delivery destination ranking information by using the IP address and the MAC address of the client terminal and the MAC address of the access point which are the network information sent together with the print data (ACT 114), delivers to the image forming apparatuses the print data which is temporarily accumulated in the HDD 904 together with a job control instruction which is determined from predicted values in accordance with the image forming apparatuses, the predicted values, the rankings and the like recorded in all the matching records, and records such information as a record of a print data delivery and a print result on the HDD 904 as shown in FIG. 14 (ACT 116).

At this time, the print data may not be necessarily delivered to all the image forming apparatuses and the number of the image forming apparatuses to which the print data is to be delivered may be limited in accordance with ranking values.

Next, the printing process flow of the image forming apparatus will be described using the flowchart shown in FIG. 12. The processes in this flow are executed by the processor 801.

Once the print data and the print job control settings are accumulated (ACT 201, ACT 219), the image forming apparatus analyzes the job control instruction (ACT 220) and performs a process related to the printing of the print data based on the settings (ACT 221). For example, in a case of an image forming apparatus, of which the predicted value shown in the settings of the table shown in FIG. 9 is 80% to 100%, the priority of “high” and “execution” of the raster image process are set in the received job control instruction on the side of the print data delivery device 1. In this case, the image forming apparatus performs the raster image process with a high priority after receiving the print data and performs the processes up to a state in which the printing can be performed immediately after a request for the printing (ACT 207 to ACT 210).

Similarly, in a case of an image forming apparatus, of which the predicted value is 60% to less than 80%, the image forming apparatus performs the raster image process with a low priority after receiving the print data. In addition, in a case of an image forming apparatus, of which the predicted value is 40% to less than 60%, a raster image process execution priority is low and the execution is controlled to be put on hold by 300 seconds.

These processes are effective in that (1) the execution of the printing is put on hold in a device having a low print output possibility, and thus when there is a high-priority print job, the printing waiting time of the print job is shortened and (2) when target print data is output from another image forming apparatus, the execution of an unnecessary raster image process is prevented.

Examples of a method of delaying the execution timing include (1) a method of controlling the execution timing by using a job control instruction, (2) a method of delaying the timing at which the print data delivery device 1 sends the print data to the image forming apparatus, and the like.

In addition, in a case of an image forming apparatus, of which the predicted value is less than 40%, the printing possibility is extremely low. Accordingly, as the printing, a process of only receiving the print data is performed, or even the previous transmission of the print data is not performed.

In this manner, the print job control setting information is delivered together with the print data to control the printing of the image forming apparatus, and thus when the predicted value (determination value) in the print data delivery device is high, it is allowed to perform the process in a positive manner in order to shorten the printing time, and the gradual shortening of the printing time and the reduction of the unnecessary process which is performed by the image forming apparatus can be flexibly controlled in a balanced manner as the predicted value becomes low.

Next, a user moves up to an image forming apparatus to be allowed to perform the printing, selects print data to be printed from among the print data registered therein, and performs the printing thereof (ACT 211 to ACT 218). At this time, the printing waiting time changes depending on the predicted value of the image forming apparatus which is predicted by the above-described print data delivery device 1. When the predicted value of the print data delivery device 1 is 100%, the selected print data is already been received (ACT 214, YES) and the raster image process is performed with a high priority (ACT 213, YES). Accordingly, the printing can be promptly started and the waiting time of the user is shortened as much as possible.

At the time when the printing is completed, the image forming apparatus delivers a printing completion notification to the print data delivery device 1 (ACT 218). The print data delivery device 1 receiving the printing completion notification records the image forming apparatus which executed the printing and a printing completion time in the print data delivery and print result record of the table shown in FIG. 14. In addition, an instruction for deleting the print data is delivered to the image forming apparatus to which the print data is previously delivered, the print data temporarily stored in the print data delivery device 1 is deleted, and the printing ends.

In addition, in a case in which the value of prediction about the printing by a target image forming apparatus is 60% or more, the selected print data is previously received despite the low priority and the raster image process is performed when a working situation of the image forming apparatus is at a low level. Therefore, the printing is promptly started as in the case in which the value of prediction is 100% and the user's waiting time is shortened as much as possible.

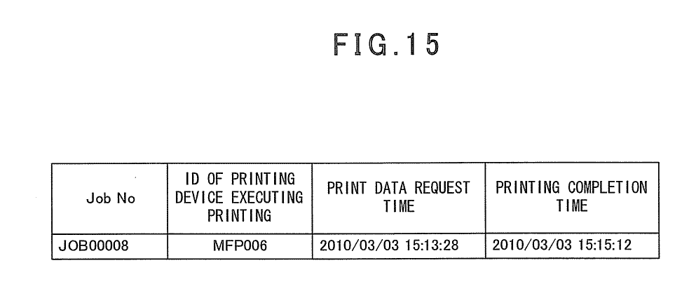

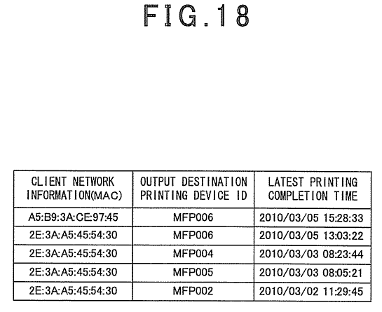

If the working situation of the image forming apparatus is not at a low level, another user performs the printing earlier, and as a result, the former user is put on hold until the printing ends and this is beyond a range to be solved by the exemplary embodiments. When the predicted value is less than 60%, the raster image process is not previously performed, and thus the waiting time is almost not shortened. However, in this case, this is recorded as a print result exception record as in FIG. 15 and the table of FIG. 18 is sequentially updated. The following printing is handled by performing an exception process to be described later.

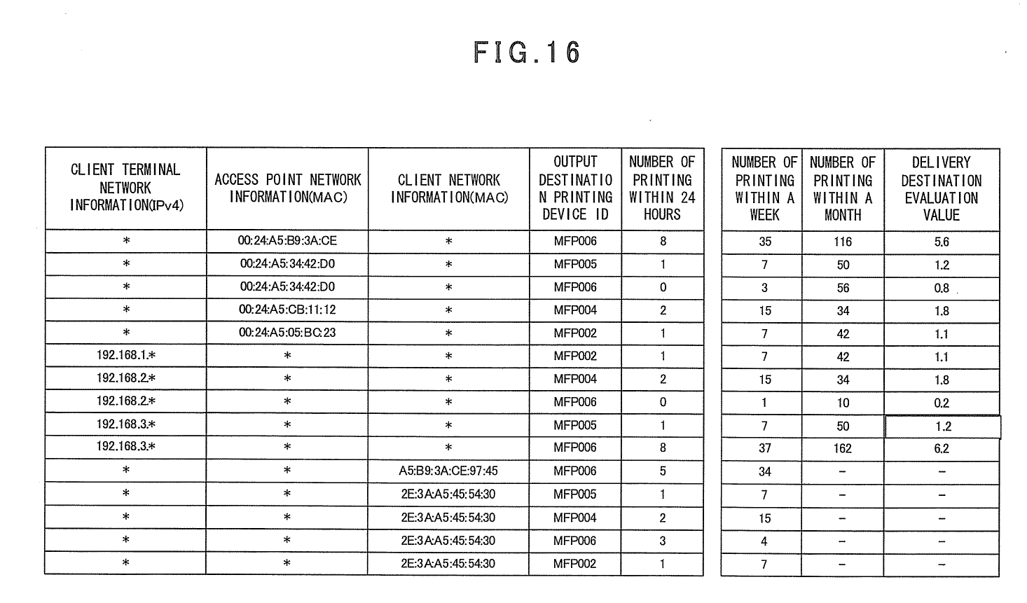

Next, the update of the print data delivery destination ranking information will be described. The print data delivery destination rankings are updated on a regular basis per a certain period of time (for example, 24 hours) and a print result summary is made as shown in FIG. 16 on the basis of the print job record shown in FIG. 13, the print data delivery and print result record shown in FIG. 14, and the print result exception record shown in FIG. 15.

In the print result summary, the number of printing is counted within 24 hours, within a week, and within a month on the basis of a time at which the relationship with the network information is updated for each image forming apparatus executing the printing. Using the counted numerical value, an evaluation value for previous delivery of print data (“a delivery destination evaluation value” in the table) is calculated as follows:

Evaluation Value for Previous Delivery Of Print Data=(the Number of Printing within 24 Hours+the Number of Printing within a Week/7+the Number of Printing within a Month/30)/3.

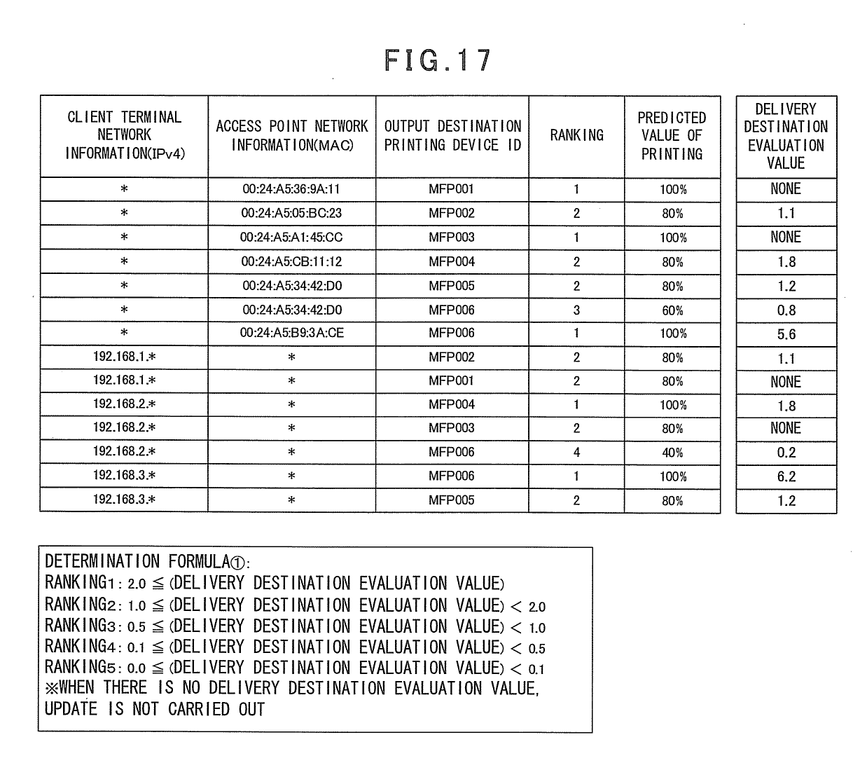

In addition, a new table shown in FIG. 17 is made by updating the table shown in FIG. 9. In the table shown in FIG. 17, the image forming apparatuses to which the print data is previously delivered are sorted based on the IP addresses which are sent from the client terminals and the MAC addresses of the access points and are ranked in descending order according to the evaluation value for previous delivery of print data. As the predicted values, 100%, 80%, and 60% are set from the top of the rankings.

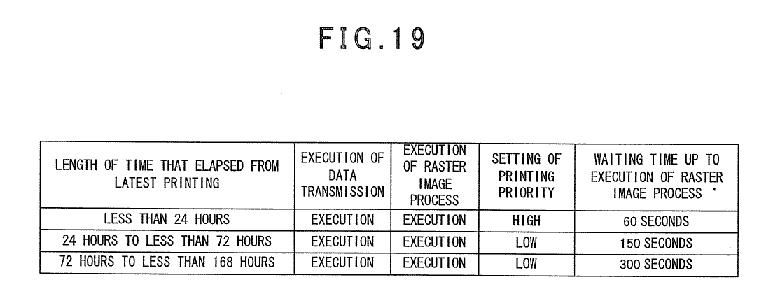

Next, the exception process will be described. The exception process information of the table shown in FIG. 18 is that exceptional results of the printing by the image forming apparatuses which are determined according to the print data delivery destination rankings are gathered for each of the MAC addresses of the client terminals. Regarding the print jobs from the client terminals having the MAC address which is registered in this exception process information, a job control instruction is generated in accordance with the job control instruction settings in the exception process in the table shown in FIG. 19 in accordance with an elapsed time from the latest printing time, and the print data is previously transmitted for a certain period of time to the image forming apparatus which is registered in the exception process information in addition to the image forming apparatus which is determined according to the print data delivery destination rankings.

Accordingly, when the printing is performed by the image forming apparatus performing the normal printing before the raster image process in the image forming apparatus to which the print data is exceptionally sent is performed, the print data is deleted, and thus the unnecessary raster image process is not performed.

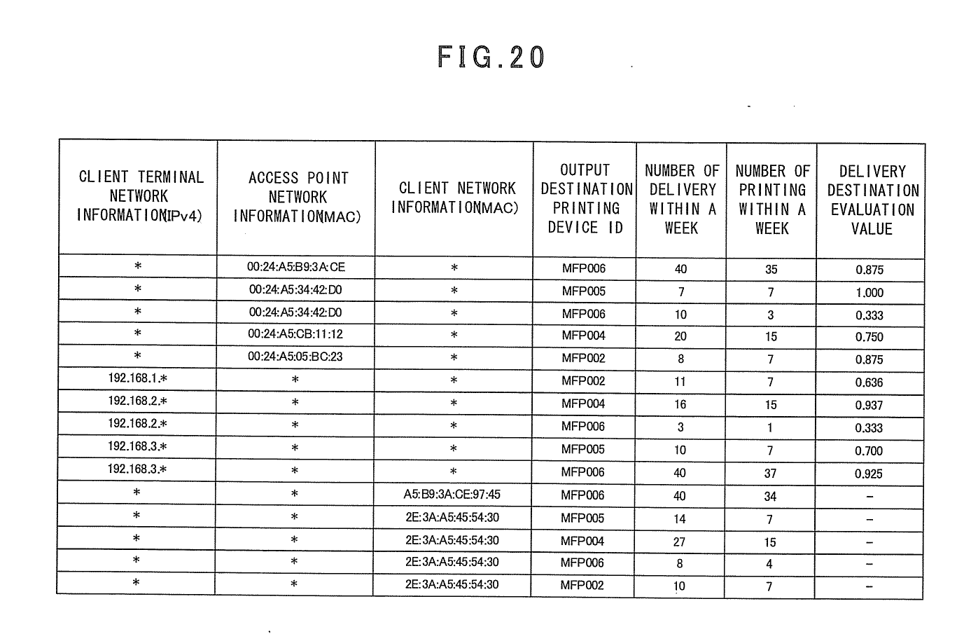

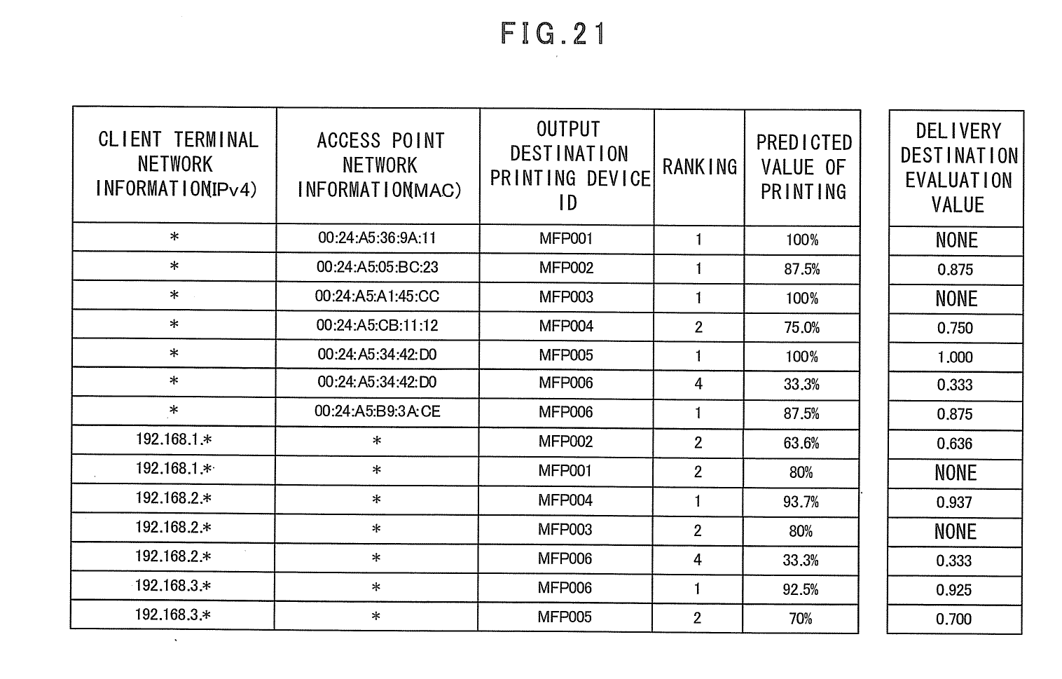

FIGS. 20 and 21 are tables for explaining another method of calculating an Evaluation Value for Previous Delivery Print Data for previous delivery of print data.

The Evaluation Value for Previous Delivery Of Print Data shown in FIG. 20 is calculated as follows, for example,:

Evaluation Value for Previous Delivery Of Print Data=(the Number of Printing within a Week)/(the Number of Sending within a Week).

The Evaluation Value for Previous Delivery of Print Data is converted into a percentage to determine the predicted value of the printing.

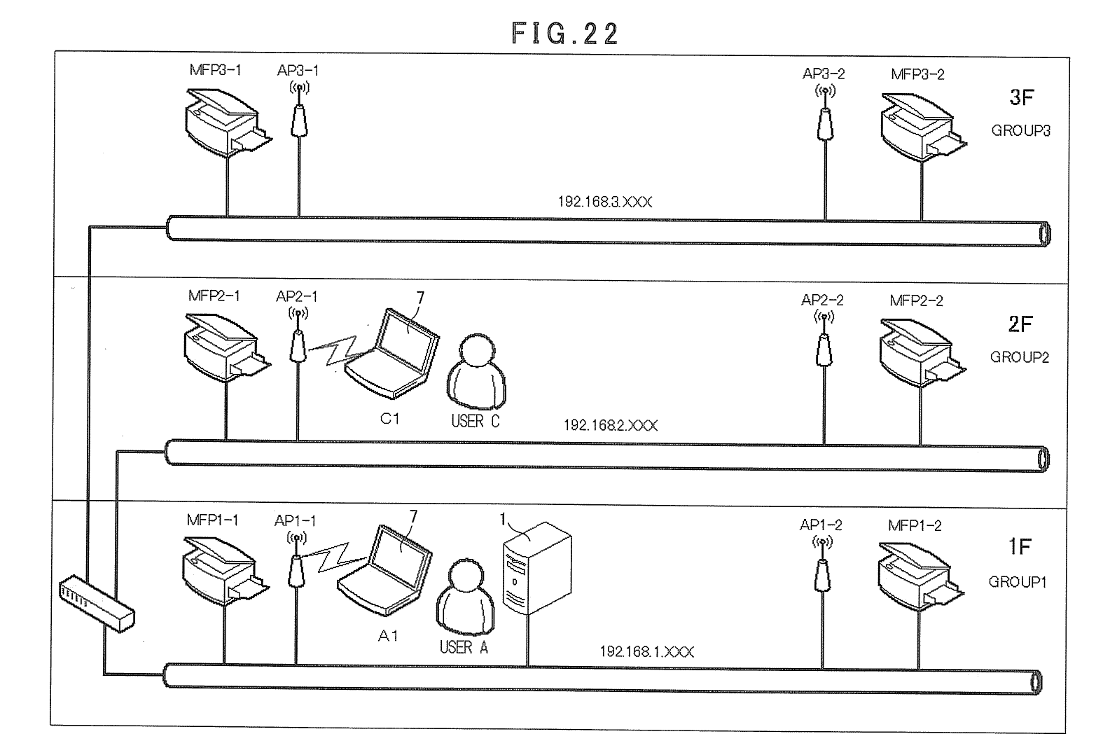

The above-described control process will be described with a detailed example using FIG. 22.

One day, a user A of a group 1 may issue a printing instruction from a client terminal at a position of a user's seat A1 of 1F.

At this time, the client terminal is network-connected by a wireless LAN and the MAC address of the access point which is connected can be obtained. Accordingly, the IP address and the MAC address of the client terminal, the MAC address of the access point, user information, print data and the like are sent to the print data delivery device 1.

Next, the print data delivery device 1 retrieves the print data delivery destination ranking information of FIG. 9 by using the sent network information as a key, and specifies image forming apparatus candidates having a high possibility of performing the printing by the user.

The print data delivery device 1 delivers the print data accumulated in the HDD 904 to the specified image forming apparatuses having a high possibility of performing the printing by the user, and at the same time, generates a job control instruction based on the print job control information from the predicted values obtained and delivers the job control instruction to the specified image forming apparatuses.

In this case, an image forming apparatus MFP1-1, a predicted value 100%, an image forming apparatus MFP1-2, a predicted value 80% are obtained from the MAC address (00:24:A5:36:9A:11) of AP1 and the IP address (192.168.1.*) of the client terminal, and the print data and the job control instruction corresponding to the predicted value 100% are transmitted to the image forming apparatus MFP1-1 and the print data and the job control instruction corresponding to the predicted value 80% are transmitted to the image forming apparatus MFP1-2.

The image forming apparatuses MFP1-1 and MFP1-2 process the received print data on the basis of the job control instruction. In this case, the image forming apparatus MFP1-1 performs the raster image process after reception of the print data with a “high” priority, and the image forming apparatus MFP1-2 performs the raster image process with a “low” priority. These are put on hold to be able to perform the printing.

The user A moves to the nearest image forming apparatus MFP1-1 from the position of A1 and requests the printing. Since the image forming apparatus MFP1-1 processes the print data, which is requested to be printed by the user A, before the request of the printing, the printing is promptly started.

When the printing ends, the image forming apparatus MFP1-1 sends a printing completion notification to the print data delivery device 1. When receiving the printing completion notification, the print data delivery device 1 sends a print data deletion notification to the image forming apparatus MFP1-2 to which the print data is previously sent, and the process advances to a process of deleting the print data accumulated in the print data delivery device 1. In this case, the print data is delivered to all of the image forming apparatuses which are obtained from the print data delivery destination ranking information. However, the number of image forming apparatuses to which the print data is to be delivered may be limited up to, for example, the ranking 1.

Next, a user C of a group 3 has a user's seat in 3F, and in most cases, the client terminal is also connected to the network by AP3-1 or the like in 3F and an image forming apparatus MFP3-1 or MFP3-2 performs the printing. One day, a meeting may be carried out in a meeting room in 2F and the printing may be performed from the client terminal at a position of C1 of 2F. However, in the past, the user might never use the image forming apparatus which is present in 2F. At this time, since the PC is connected to AP2-1 by a wireless LAN, the network information which is sent to the print data delivery device 1 includes the MAC address of the client terminal which is always used by the user C, the IP address which is assigned from the AP2-1, and the MAC address of the AP2-1. The print data delivery destination ranking information of FIG. 9 is retrieved by using the network information which is sent as in the above-described example as a key, and the print data and the print job control information based on the predicted values are delivered to the obtained image forming apparatuses.

In this case, an image forming apparatus MFP2-1, a predicted value 100%, an image forming apparatus MFP2-2, and a predicted value 80% are obtained from the MAC address (00:24:A5:A1:45:CC) of the AP2-1 and the IP address (192.168.2.*) of the client terminal, and the print data and the print job control information corresponding to the predicted value 100% are transmitted to the image forming apparatus MFP2-1 and the print data and the print job control information corresponding to the predicted value 80% are transmitted to the image forming apparatus MFP2-2.

The print data is processed by the image forming apparatuses MFP2-1 and 2-2 as described above, and the user C can perform the printing with very little waiting time.

In this manner, the print data can be previously delivered with high accuracy even to an image forming apparatus which did not perform the printing in the past, and thus the printing waiting time can be shortened as much as possible.

Next, a case is considered in which the user A of the group 1 performs the printing at the position of the user's seat A1 of 1F as usual and the printing is performed by the image forming apparatus MFP2-1 in 2F of the meeting room. In this case, as the network information at the time when the client terminal performs the printing, the access point AP1-1 (00:24:A5:36:9A:11) in 1F and the IP address (192.168.1.*) are sent to the print data delivery device 1. Therefore, when retrieving the print data delivery destination ranking information of Table 5, the print data is sent only to the image forming apparatuses MFP1-1 and MFP1-2 in 1F. Accordingly, since the print data is not previously sent to the image forming apparatus MFP2-1 in 2F, the printing waiting time for performing the process from the transmission and the raster image process for the print data is not reduced. In such a case, the MAC address of the client terminal, the image forming apparatus MFP2-1 actually performing the printing, a time at which the printing request is received, and a time at which the printing is completed are recorded in the print result exception record in order to handle the next printing. Regarding the print job from the MAC address of the registered client terminal, the print data and the job control instruction are also previously delivered to the registered image forming apparatus in addition to the normal delivery destination for a certain period of time. In the job control instruction which is sent at this time, awaiting time for the raster image process is set in accordance with the length of time that elapsed from the latest printing completion time. That is, when the user A performs the printing at the position of the user's seat A1 of 1F, the print data, to which the job control instruction with the waiting time for the raster image process (according to the table of FIG. 19, 60 seconds) is added, is also delivered to the image forming apparatus MFP2-1 in addition to the image forming apparatuses MFP1-1 and MFP1-2 corresponding to the normal delivery destinations for a certain period of time (for example, in the case of less than 24 hours).

In this manner, when the printing is performed from the image forming apparatus performing the normal printing before execution of the raster image process in the image forming apparatus to which the print data is exceptionally sent, the print data is deleted and the unnecessary raster image process may not be performed. As another method, instead of setting the waiting time for the raster image process in the job control instruction, the print data delivery device 1 may control the timing of transmission of the print data to be sent to the exceptive image forming apparatus to be delayed.

Due to such a configuration, an increase in the printing waiting time due to the network traffic occurring by the data transmission of the print data which will not be printed and an increase in the processing time occurring by the execution of the raster image process for the print data which will not be printed can be prevented. In addition, the timing of the raster image process to be executed by the image forming apparatus and the priority can be optimally controlled, and the printing waiting time when a user performs a pull printing can be shortened.

In this embodiment, the image forming apparatus having a high possibility of printing by the user is specified from, for example, the user ID which is the identification information of a user, the identification information on the network of the client terminal 7 which is instructed to perform the printing by the user, the identification information on the network of the network device such as a router which is connected to the client terminal 7, or the information (for example, IP address) which is necessary to configure the computer network, and in this manner, the execution of the unnecessary transmission of the print data and the unnecessary raster image process are suppressed. Accordingly, an increase in the printing waiting time due to an increase in the network traffic occurring by the print data which will not be printed and an increase in the raster image process time is prevented.

In addition, when the print data is transmitted to the image forming apparatus, a job control instruction of the printing which is performed by the image forming apparatus is added, and the presence or absence of the execution of the raster image process which is executed by the image forming apparatus, the timings of the execution, or the priority is controlled, whereby the printing waiting time can be shortened and optimized.

The operations in the above-described print data delivery device 1 are realized by executing a print data delivery program which is stored in the memory 903 on the processor 901. In addition, the operations in the processes in the image forming apparatuses 2 (MFP1-1 to MFP3-2) are realized by executing an image forming program which is stored in the memory 803 on the processor 801.

Furthermore, a program for executing the above-described operations on the computers constituting the print data delivery device 1 and the image forming apparatuses 2 can be provided as a print data delivery program and an image forming program. In this embodiment, an example is provided in which the program for realizing the functions embodying the exemplary embodiments is recorded in advance on a storage area provided in the device, but the exemplary embodiments are not limited thereto. The same program may be downloaded to the device from the network or may be stored in a computer-readable recording medium to be installed in the device. The recording medium may have any form if it is a computer-readable recording medium which can store the program. Specifically, examples of the recording medium include an internal memory device such as a ROM and a RAM which is mounted on the interior of the computer, a portable recording medium such as a CD-ROM, a flexible disk, a DVD disk, a magnetic optical disk, and an IC card, a database which holds a computer program, other computers and databases thereof, and a transmission medium on the line. In addition, the functions which are obtained by installing or downloading in advance may be realized in cooperation with an operating system (OS) in the device.

A part or the whole of the program may be an execution module which is dynamically generated.

In addition, needless to say, at least some of the various processes which are realized by executing the program on the processor can also be executed in a circuit manner by the ASIC 802.

Furthermore, in this embodiment, though both of the print data delivery device 1 and the image forming apparatuses 2 are connected to same Local-Area-Network, the system may be configured so as to perform a function of the print data delivery device 1 using the cloud computing service, or be configured using Wide-Network to connect the image forming apparatuses 2 at distant offices respectively.

As described above, according to the technique described herein, it is possible to provide a technique which contributes to a reduction in the printing waiting time in using the image forming apparatus while suppressing an excessive increase in the traffic and the execution of the unnecessary raster image process in the image forming apparatus.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A print data delivery device comprising:
a print data receiving unit which receives print data which is transmitted from a client terminal;
a transmission source information acquisition unit which acquires transmission source identification information corresponding to a transmission source for the print data which is received by the print data receiving unit;
a delivery destination determination unit which determines as a print data delivery destination at least one image forming apparatus which is associated in advance with the transmission source identification information as an apparatus which is selected at a frequency which is equal to or more than a predetermined number of times within a predetermined period of time to be allowed to execute printing based on the print data by a user corresponding to the transmission source identification information which is acquired by the transmission source information acquisition unit; and
a print data delivery unit which delivers the print data received by the print data receiving unit toward the at least one image forming apparatus which is determined by the delivery destination determination unit.

2. The device of claim 1, further comprising:
a status information acquisition unit which acquires execution status information showing an image forming apparatus which is actually selected by the user as an apparatus to be allowed to execute the printing based on the received print data from among a plurality of image forming apparatuses to which the print data is delivered in association with the transmission source identification information corresponding to each print data; and
a priority setting unit which sets the priority higher for an image forming apparatus which was selected at a high frequency in the past as an apparatus which is allowed to execute the printing based on the print data on the basis of the information acquired by the status information acquisition unit,
wherein the print data delivery unit preferentially delivers the print data to the image forming apparatus of which the priority set by the priority setting unit is high.

3. The device of claim 1, further comprising:
a status information acquisition unit which acquires execution status information showing an image forming apparatus which actually executes the printing based on the received print data from among a plurality of image forming apparatuses to which the print data is delivered in association with the transmission source identification information corresponding to each print data; and
a priority setting unit which sets the priority higher for an image forming apparatus which was selected at a high frequency in the past as an apparatus which is allowed to execute the printing based on the print data on the basis of the information acquired by the status information acquisition unit,
wherein the print data delivery unit sets, in each print data to be delivered, an execution control command to preferentially start an execution of a predetermined process based on the delivered print data for an image forming apparatus of which the priority set by the priority setting unit is high.

4. The device of claim 1, further comprising:
a status information acquisition unit which acquires execution status information showing an image forming apparatus which actually executes the printing based on the delivered print data from among a plurality of image forming apparatuses to which the print data is delivered in association with the transmission source identification information corresponding to each print data; and
a delivery destination modifying unit which modifies the at least one image forming apparatus as a delivery destination which is associated in advance with the transmission source identification information.

5. The device of claim 1, further comprising:
a status information acquisition unit which acquires execution status information showing a certain image forming apparatus which actually executes the printing based on the delivered print data from among a plurality of image forming apparatuses to which the print data is delivered in association with the transmission source identification information corresponding to each print data,
wherein when the certain image forming apparatus which is shown by the execution status information acquired by the status information acquisition unit in association with arbitrary transmission source identification information is not previously associated with the transmission source identification information, the delivery destination determination unit also adds the certain image forming apparatus to the print data delivery destination for a predetermined period of time.

6. The device of claim 1,
wherein the transmission source identification information is at least any of an IP address version 4 of a client terminal, an IP address version 6 of the client terminal, a MAC address of the client terminal, a MAC address of a network device for connecting the client terminal to a network, and a user ID.

7. The device of claim 3,
wherein the predetermined process based on the delivered print data is a raster image processing.

8. A print data delivering method comprising:
receiving print data which is transmitted from a client terminal;
acquiring transmission source identification information corresponding to a transmission source for the print data which is received;
determining as a print data delivery destination at least one image forming apparatus which is associated in advance with the transmission source identification information as an apparatus which is selected at a frequency which is equal to or more than a predetermined number of times within a predetermined period of time to be allowed to execute printing based on the print data by a user corresponding to the transmission source identification information which is acquired; and
delivering the print data received toward the at least one image forming apparatus which is determined.

9. The method of claim 8, further comprising:
acquiring execution status information showing an image forming apparatus which is actually selected by the user as an apparatus to be allowed to execute the printing based on the received print data from among a plurality of image forming apparatuses to which the print data is delivered in association with the transmission source identification information corresponding to each print data; and
setting the priority higher for an image forming apparatus which was selected at a high frequency in the past as an apparatus which is allowed to execute the printing based on the print data on the basis of the information acquired,
wherein preferentially delivering the print data to the image forming apparatus of which the priority set is high.

10. The method of claim 8, further comprising:
acquiring execution status information showing an image forming apparatus which actually executes the printing based on the received print data from among a plurality of image forming apparatuses to which the print data is delivered in association with the transmission source identification information corresponding to each print data; and
setting the priority higher for an image forming apparatus which was selected at a high frequency in the past as an apparatus which is allowed to execute the printing based on the print data on the basis of the information acquired,
wherein setting, in each print data to be delivered, an execution control command to preferentially start an execution of a predetermined process based on the delivered print data for an image forming apparatus of which the priority set is high.

11. The method of claim 8, further comprising:
acquiring execution status information showing an image forming apparatus which actually executes the printing based on the delivered print data from among a plurality of image forming apparatuses to which the print data is delivered in association with the transmission source identification information corresponding to each print data; and
modifying the at least one image forming apparatus as a delivery destination which is associated in advance with the transmission source identification information.

12. The method of claim 8, further comprising:
acquiring execution status information showing a certain image forming apparatus which actually executes the printing based on the delivered print data from among a plurality of image forming apparatuses to which the print data is delivered in association with the transmission source identification information corresponding to each print data,
wherein when the certain image forming apparatus which is shown by the execution status information acquired in association with arbitrary transmission source identification information is not previously associated with the transmission source identification information, adding the certain image forming apparatus to the print data delivery destination for a predetermined period of time.

13. The method of claim 8,
wherein the transmission source identification information is at least any of an IP address version 4 of a client terminal, an IP address version 6 of the client terminal, a MAC address of the client terminal, a MAC address of a network device for connecting the client terminal to a network, and a user ID.

14. An image forming system comprising:
a print data delivery device which includes a print data receiving unit which receives print data which is transmitted from a client terminal, a transmission source information acquisition unit which acquires transmission source identification information corresponding to a transmission source for the print data which is received by the print data receiving unit, a delivery destination determination unit which determines as a print data delivery destination at least one image forming apparatus which is associated in advance with the transmission source identification information as an apparatus which is selected at a frequency which is equal to or more than a predetermined number of times within a predetermined period of time to be allowed to execute printing based on the print data by a user corresponding to the transmission source identification information which is acquired by the transmission source information acquisition unit, and a print data delivery unit which delivers the print data received b determination unit; and
an image forming apparatus which includes a print data receiving unit which receives print data which is delivered from the print data delivery device, a command analysis unit which analyzes an execution control command which is added to the print data, and a process start control unit which controls an execution start timing of a predetermined process based on the print data which is received by the print data receiving unit on the basis of the execution control command which is analyzed by the command analysis unit.

15. The system of claim 14, further comprising:
a status information acquisition unit which acquires execution status information showing an image forming apparatus which is actually selected by the user as an apparatus to be allowed to execute the printing based on the received print data from among a plurality of image forming apparatuses to which the print data is delivered in association with the transmission source identification information corresponding to each print data; and
a priority setting unit which sets the priority higher for an image forming apparatus which was selected at a high frequency in the past as an apparatus which is allowed to execute the printing based on the print data on the basis of the information acquired by the status information acquisition unit,
wherein the print data delivery unit preferentially delivers the print data to the image forming apparatus of which the priority set by the priority setting unit is high.

16. The system of claim 14, further comprising:
a status information acquisition unit which acquires execution status information showing an image forming apparatus which actually executes the printing based on the received print data from among a plurality of image forming apparatuses to which the print data is delivered in association y the print data receiving unit toward the at least one image forming apparatus which is determined by the delivery destination with the transmission source identification information corresponding to each print data; and
a priority setting unit which sets the priority higher for an image forming apparatus which was selected at a high frequency in the past as an apparatus which is allowed to execute the printing based on the print data on the basis of the information acquired by the status information acquisition unit,
wherein the print data delivery unit sets, in each print data to be delivered, an execution control command to preferentially start an execution of a predetermined process based on the delivered print data for an image forming apparatus of which the priority set by the priority setting unit is high.

17. The system of claim 14, further comprising:
a status information acquisition unit which acquires execution status information showing an image forming apparatus which actually executes the printing based on the delivered print data from among a plurality of image forming apparatuses to which the print data is delivered in association with the transmission source identification information corresponding to each print data; and
a delivery destination modifying unit which modifies the at least one image forming apparatus as a delivery destination which is associated in advance with the transmission source identification information.

18. The system of claim 14, further comprising:
a status information acquisition unit which acquires execution status information showing a certain image forming apparatus which actually executes the printing based on the delivered print data from among a plurality of image forming apparatuses to which the print data is delivered in association with the transmission source identification information corresponding to each print data,
wherein when the certain image forming apparatus which is shown by the execution status information acquired by the status information acquisition unit in association with arbitrary transmission source identification information is not previously associated with the transmission source identification information, the delivery destination determination unit also adds the certain image forming apparatus to the print data delivery destination for a predetermined period of time.

19. The system of claim 14,
wherein the transmission source identification information is at least any of an IP address version 4 of a client terminal, an IP address version 6 of the client terminal, a MAC address of the client terminal, a MAC address of a network device for connecting the client terminal to a network, and a user ID.

20. The system of claim 14,
wherein the predetermined process based on the delivered print data is a raster image processing.
